(19) United States
(12) Patent Application Publication
(10) Pub. No.: US 2010/0053802 A1
(43) Pub. Date: Mar. 4, 2010

(54) Low Power Disk-Drive Motor Driver

(76) Inventor: Masaki Yamashita, Niiza-shi (JP)

Correspondence Address: TEXAS INSTRUMENTS INCORPORATED, P O BOX 655474, M/S 3999, DALLAS, TX, 75265, US

(21) Appl. No.: 12/199,588

(22) Filed: Aug. 27, 2008

(51) Int. Cl. G11B 5/596

(52) U.S. Cl. 360/78.04; G9B/5.216

(57) ABSTRACT

One embodiment of the invention includes a disk-drive motor control system. The system comprises a seek mode power supply configured to provide a first voltage corresponding to a seek mode associated with a disk-drive voice control motor (VCM). The system also includes a track mode power supply configured to provide a second voltage corresponding to a tracking mode associated with the disk-drive VCM. The first voltage can be greater than the second voltage. The system further includes a disk-drive motor driver configured to provide a current to the disk-drive VCM at a first magnitude in the seek mode based on the first voltage, at a second magnitude in the tracking mode based on the second voltage, and at a third magnitude in a head-retraction mode.

### TECHNICAL FIELD

This invention relates to electronic circuits, and more specifically to a disk-drive motor driver.

### BACKGROUND

Magnetic disk-drives, such as hard-drives, are implemented in almost all personal computers and enterprise-class server computers. Typical magnetic disk drives are operated by a spindle motor (SPM) that spins the magnetic disk and a voice control motor (VCM) that drives and positions the magnetic disk read and/or write head. As an example, the VCM can be a linearly operated servo motor that can operate in a seek mode and in a tracking mode. In the seek mode, the VCM is moved across the magnetic disk to seek a specific location to read data from or write data to the magnetic disk. In the tracking mode, the VCM remains stationary or moves very slowly to stay on-track of the disk while data is being read from or written to the magnetic disk.

### SUMMARY

One embodiment of the invention includes a disk-drive motor control system. The system comprises a seek mode power supply configured to provide a first voltage corresponding to a seek mode associated with a disk-drive voice control motor (VCM). The system also includes a track mode power supply configured to provide a second voltage corresponding to a tracking mode associated with the disk-drive VCM. The first voltage can be greater than the second voltage. The system further includes a disk-drive motor driver configured to provide a current to the disk-drive VCM at a first magnitude in the seek mode based on the first voltage, at a second magnitude in the tracking mode based on the second voltage, and at a third magnitude in a head-retraction mode.

Another embodiment of the invention includes a method for controlling a disk-drive. The method comprises switching a disk-drive voice control motor (VCM) to a seek mode power supply via a first H-bridge circuit upon the disk-drive entering a seek mode and providing a current at a first magnitude to the disk-drive VCM through the first H-bridge circuit during the seek mode. The method further includes switching the disk-drive VCM to a tracking mode power supply via a second H-bridge circuit upon the disk-drive entering a tracking mode, and providing the current at a second magnitude to the disk-drive VCM through the second H-bridge circuit during the tracking mode. The first magnitude can be greater than the second magnitude.

Another embodiment of in the invention includes a disk-drive motor control system. The system comprises means for providing a first voltage corresponding to a seek mode associated with a disk-drive voice control motor (VCM) and means for providing a second voltage corresponding to a tracking mode associated with the disk-drive VCM, the first voltage being greater than the second voltage. The system also comprises means for providing a third voltage corresponding to a head-retraction mode associated with the disk-drive VCM. The system further comprises means for providing a current to the disk-drive VCM at one of a first magnitude based on the first voltage in the seek mode, a second magnitude based on the second voltage in the tracking mode, and a third magnitude based on the third voltage in the head-retraction mode.

### BRIEF DESCRIPTION OF THE DRAWINGS

FIG. 1 illustrates an example of a disk-drive motor control system in accordance with an aspect of the invention.

FIG. 2 illustrates an example of a disk-drive motor driver in accordance with an aspect of the invention.

FIG. 3 illustrates another example of a disk-drive motor driver in accordance with an aspect of the invention.

FIG. 4 illustrates an example of a method for controlling a disk-drive voice coil motor in accordance with an aspect of the invention.

### DETAILED DESCRIPTION

The invention relates to electronic circuits, and more specifically to a disk-drive motor driver. The disk-drive motor driver can include a voice control motor (VCM) output stage that controls a VCM and a spindle motor (SPM) output stage that controls an SPM. A seek mode power supply provides a seek mode voltage to the disk-drive motor driver that is provided to the SPM output stage and the VCM output stage. Thus, the seek mode voltage is provided to control the SPM and the VCM during a seek mode. A tracking mode power supply provides a tracking mode voltage to the VCM output stage, with the tracking mode voltage being less than the seek mode voltage. Thus, during a tracking mode, the VCM output stage switches to the tracking mode voltage to conserve power.

The VCM is controlled based on providing current through the VCM in one of two directions. As such, current that is provided in a first direction through the VCM moves the VCM in one direction, and current that is provided in the other direction through the VCM moves the VCM in the other direction. Thus, the VCM output stage can include an H-bridge circuit to provide the current through the VCM based on a pair of control signals. As one example, the VCM output stage can also include a set of switches that switch the H-bridge circuit to the seek mode voltage in the seek mode and to the tracking mode voltage during the tracking mode. As another example, the VCM output stage can include two H-bridge circuits, a first H-bridge circuit that is coupled to the seek mode voltage and a second H-bridge circuit that is coupled to the tracking mode voltage. Thus, in the seek mode, the VCM output stage can provide the current to the VCM using the first H-bridge circuit, and in the tracking mode, the VCM output stage can provide the current to the VCM using the second H-bridge circuit.

The disk-drive motor driver can also operate in a head-retraction mode. As an example, upon there being insufficient seek mode voltage to spin the SPM or to maintain adequate current through the VCM, the disk-drive motor driver can enter the head-retraction mode to generate a sufficient amount of current through the VCM to retract the magnetic disk read/write head to avoid damage to the magnetic disk. In the head-retraction mode, back-electromagnetic field voltage of the SPM can be rectified to generate a head-retraction voltage. The head-retraction voltage is thus implemented to provide the current through the VCM in a specific direction to retract it. As an example, the disk-drive motor driver can include a switch that provides a current path through the H-bridge circuit to provide current to the VCM to retract the read/write head regardless of the seek mode voltage or the tracking mode voltage. As another example, the disk-drive motor driver can provide the current through the first H-bridge circuit to the VCM to retract the read/write head.

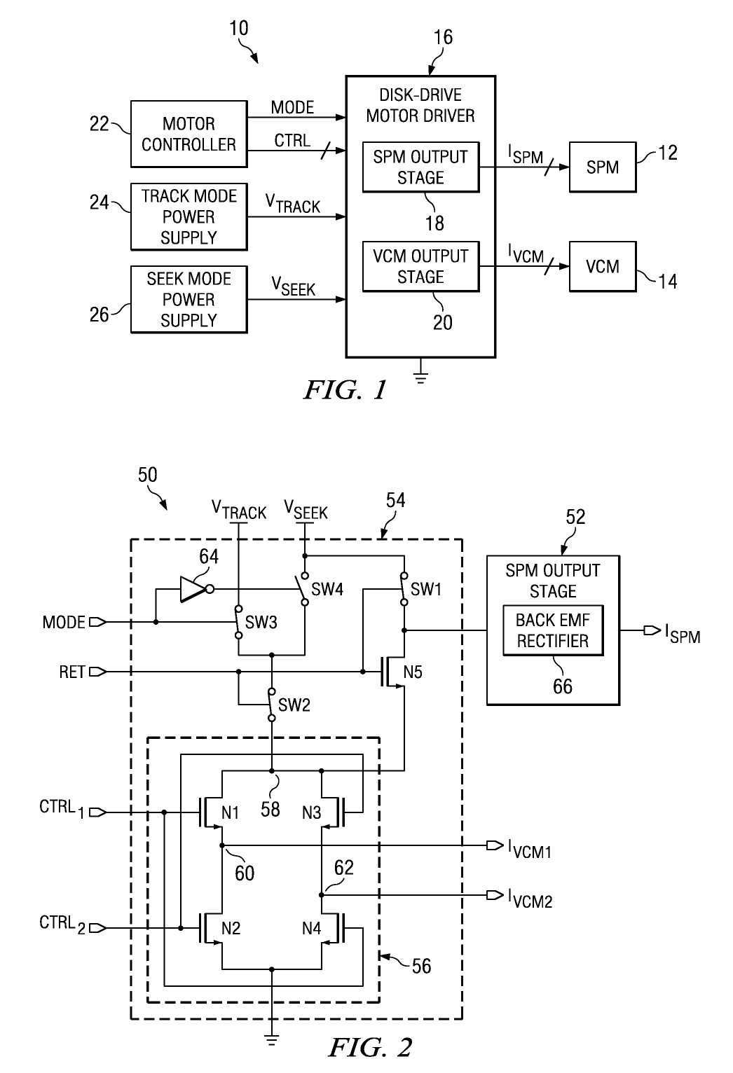

FIG. 1 illustrates an example of a disk-drive motor control system 10 in accordance with an aspect of the invention. The disk-drive motor control system 10 can be included in any of a variety of magnetic disk-drive systems, such as a hard-drive for a personal computer or laptop computer. The disk-drive motor control system 10 includes a spindle motor (SPM) 12 that spins an associated magnetic disk (not shown) and a voice control motor (VCM) 14 that drives and positions an associated magnetic disk read and/or write head (not shown).

The disk-drive motor control system 10 also includes a disk-drive motor driver 16 that is configured to provide currents to the SPM 12 and the VCM 14. Specifically, the disk-drive motor driver 16 includes an SPM output stage 18 and a VCM output stage 20. In the example of FIG. 1, the SPM output stage 18 provides a current I_{SPM} to the SPM 12 to spin the magnetic disk. As an example, the SPM 12 can be a three-phase motor, such that the current I_{SPM} could be a three-phase current. The VCM output stage 20 provides a current I_{VCM} to the VCM 14 to control the position of the magnetic disk read/write head. As an example, the VCM can be a linearly operated servo motor, such that the current I_{VCM} can be bi-directional to move the magnetic disk read/write head in one of two directions depending on the polarity of the current flow through the VCM 14.

The disk-drive motor control system 10 includes a motor controller 22 configured to provide command signals to the disk-drive motor driver 16 for operating the SPM 12 and the VCM 14. In the example of FIG. 1, the command signals are demonstrated as a mode signal MODE and control signals CTRL. The control signals CTRL are representative of signals that control the currents I_{SPM} and I_{VCM}. As an example, the control signals CTRL can be linear control signals that are determinative of the polarity of the current I_{VCM} through the VCM 14 and can activate the current I_{SPM} to rotate the magnetic disk via the SPM 12. The mode signal MODE is provided to the disk-drive motor driver 16 to switch the disk-drive motor driver 16 between a seek mode and a tracking mode associated with control of the VCM 14. The seek mode can correspond to the VCM 14 moving across the magnetic disk to a specific location to read data from or write data to the magnetic disk. The tracking mode can correspond to the VCM 14 remaining substantially stationary or moving slowly across the magnetic disk to remain in a specific location while data is read from or written to the magnetic disk.

The disk-drive motor control system 10 further includes a tracking mode power supply 24 that provides a voltage V_{TRACK} and a seek mode power supply 26 that provides a voltage V_{SEEK}. As an example, the tracking mode power supply 24 and the seek mode power supply 26 can each be configured as a linear power supply or a pulse-width modulated (PWM) power supply. To move the VCM 14 quickly across the magnetic disk can require substantially more power than to move the VCM 14 very slowly or to keep the VCM 14 substantially stationary. As an example, the voltage V_{SEEK} can have a magnitude of approximately 5 volts, which can be greater than the magnitude of the voltage V_{TRACK} (e.g., approximately 2-3 volts). As a result, the disk-drive motor driver 16 can switch between the voltage V_{SEEK} and the voltage V_{TRACK} in response to the mode signal MODE to generate the current I_{VCM} via the VCM output stage 20. Accordingly, the disk-drive motor driver 16 can switch to the lesser magnitude voltage V_{TRACK} during the tracking mode, thus conserving power during the tracking mode. In addition, power can be substantially conserved in the seek mode and/or the tracking mode as well based on the voltage V_{SEEK} and/or the voltage V_{TRACK}, respectively, being generated from a PWM power supply.

In addition, the SPM output stage 18 can be configured to include circuitry configured as an additional voltage source to control the VCM output stage 20. Specifically, the SPM output stage 18 can include a back-electromagnetic (EMF) rectifier that is configured to rectify back-EMF voltage associated with the SPM 12. The back-EMF voltage can thus be provided to generate the current I_{VCM} to retract the magnetic disk read/write head via the VCM 14. As an example, the back-EMF voltage can be rectified to generate the current I_{VCM} in the event of a power loss associated with one or both of the tracking mode power supply 24 and the seek mode power supply 26.

FIG. 2 illustrates an example of a disk-drive motor driver 50 in accordance with an aspect of the invention. The disk-drive motor driver 50 can be configured substantially similar to the disk-drive motor driver 16 in the example of FIG. 1. As such, reference is to be made to the example of FIG. 1 in the following description of the example of FIG. 2.

The disk-drive motor driver 50 includes an SPM output stage 52 and a VCM output stage 54. In the example of FIG. 2, the SPM output stage 52 is coupled to the seek mode voltage V_{SEEK}, such as provided from the seek mode power supply 26 in the example of FIG. 1, via a first switch SW1 that is controlled by a signal RET. As such, the seek mode voltage V_{SEEK} is provided as a positive rail voltage to power the SPM output stage 52 during the seek mode and the tracking mode. Similar to as described above, the SPM output stage 52 is configured to generate a current I_{SPM} that controls an associated SPM, such as the SPM 12 in the example of FIG. 1. Thus, the SPM output stage 52 generates the current I_{SPM} based on the seek mode voltage V_{SEEK}. As an example, the SPM output stage 52 can be configured to control the current I_{SPM} in response to one or more control signals (not shown).

The VCM output stage 54 includes an H-bridge circuit 56. The H-bridge circuit 56 includes four N-type field effect transistors (FETs) N1, N2, N3, and N4. The transistor N1 interconnects a power node 58 and a first output node 60, and has a gate that is coupled to a first control signal CTRL₁. The transistor N2 interconnects the first output node 60 and a negative rail voltage, demonstrated in the example of FIG. 2 as ground, and has a gate that is coupled to a second control signal CTRL₂. The transistor N3 interconnects the power node 58 and a second output node 62, and has a gate that is coupled to the second control signal CTRL₂. The transistor N4 interconnects the second output node 62 and ground, and has a gate that is coupled to the first control signal CTRL₁. As an example, the first and second control signals CTRL₁ and CTRL₂ can be included in the control signals CTRL in the example of FIG. 1. For example, the first and second control signals CTRL₁ and CTRL₂ can be generated from a linear amplifier that is included in the motor controller 22.

Based on the states of the control signals CTRL₁ and CTRL₂, the H-bridge circuit 56 can be configured to provide a current path for the current I_{VCM} through the associated VCM (not shown). Specifically, the example of FIG. 2 demonstrates that a current I_{VCM1} is provided from the first output node 60 and a current I_{VCM2} is provided from the second output node 62, with the associated VCM thus interconnecting the first and second output nodes 60 and 62. As a result, at a given time, one of the currents I_{VCM1} and I_{VCM2} can be provided to the associated VCM and the other of the currents I_{VCM1} and I_{VCM2} can be provided as a return path from the associated VCM to ground. The control signals CTRL₁ and CTRL₂ can thus have logic states that are mutually exclusive, such that the respective states of the control signals CTRL₁ and CTRL₂ can control the direction of the current through the associated VCM. Accordingly, the direction of movement of the magnetic disk read/write head can be appropriately controlled. As an example, the current I_{VCM1} can correspond to retracting the associated VCM, such as to move the magnetic disk read/write head toward the magnetic disk outer edge, and the current I_{VCM2} can correspond to extending the associated VCM, such as to move the magnetic disk read/write head toward the magnetic disk inner edge.

As one example, the control signal CTRL₁ can be asserted (i.e., logic high) while the control signal CTRL₂ can be de-asserted (i.e., logic low). Therefore, the transistors N1 and N4 are activated. Accordingly, current flows from the power node 58 through the transistor N1, to the associated VCM as the current I_{VCM1}, back from the associated VCM as the current I_{VCM2}, and through the transistor N4 to ground. As another example, the control signal CTRL₂ can be asserted while the control signal CTRL₁ can be de-asserted. Therefore, the transistors N2 and N3 are activated. Accordingly, current flows from the power node 58 through the transistor N3, to the associated VCM as the current I_{VCM2}, back from the associated VCM as the current I_{VCM1}, and through the transistor N2 to ground.

The VCM output stage 54 also includes a second switch SW2, a third switch SW3, and a fourth switch SW4. As an example, the switches SW2, SW3, and SW4 can be configured as transistors, such as N-type FETs. The second switch SW2 is closed during the seek mode and the tracking mode to couple the third and fourth switches SW3 and SW4 to the power node 58. The third switch SW3 interconnects the power node 58 and the tracking mode voltage V_{TRACK}, such as generated by the tracking mode power supply 24, and the fourth switch SW4 interconnects the power node 58 and the seek mode voltage V_{SEEK}. The third switch SW3 is controlled by the mode signal MODE and the fourth switch SW4 is controlled by an inverted state of the mode signal MODE via an inverter 64. Therefore, the switches SW3 and SW4 are each activated to mutually exclusively to couple the respective one of the tracking mode voltage V_{TRACK} and the seek mode voltage V_{SEEK} to the power node 58 during the respective tracking mode and seek mode. Accordingly, the respective one of the tracking mode voltage V_{TRACK} and the seek mode voltage V_{SEEK} is provided as the voltage supply to the H-bridge circuit 56 in response to the mode signal MODE. As a result, during the tracking mode, the VCM output stage 54 can generate the current to the associated VCM based on the lower magnitude tracking mode voltage V_{TRACK} to substantially reduce power consumption.

In addition, in the example of FIG. 2, the SPM output stage 52 includes a back-EMF rectifier 66. The back-EMF rectifier 66 can be configured to rectify back-EMF voltage associated with the associated SPM to provide the rectified back-EMF voltage as a voltage source for the current I_{VCM1} to the associated VCM. Specifically, the VCM output stage 54 includes an N-type FET N5 that interconnects the SPM output stage 52 and the power node 58, and has a gate that is controlled by the signal RET. As an example, the signal RET can be asserted in response to a detected power-loss associated with the tracking mode voltage V_{TRACK} and/or the seek mode power supply V_{SEEK}, thus initiating a head-retraction mode. As a result, the N-FET N5 is activated and the first switch SW1 and the second switch SW2 are each opened to decouple the SPM output stage 52 from the seek mode voltage V_{SEEK} and to decouple the power node 58 from the seek mode voltage V_{SEEK} and the tracking mode voltage V_{TRACK}, respectively. Accordingly, one of the control signals CTRL₁ and CTRL₂ can also be asserted to provide a current path from the SPM output stage 52 through the transistor N5 and through the associated VCM as the current I_{VCM1} or I_{VCM2} to ground. As a result, the magnetic disk read/write head can be retracted in event of a loss of the tracking mode voltage V_{TRACK} and/or the seek mode voltage V_{SEEK}, thus substantially preventing damage to the magnetic disk.

It is to be understood that the disk-drive motor driver 50 is not intended to be limited to the example of FIG. 2. As an example, the H-bridge circuit 56 is not limited to the use of N-type FETs, but it could implement some or all of the transistors therein as P-type FETs. In addition, the switching between the tracking mode voltage V_{TRACK} and the seek mode voltage V_{SEEK} is not limited to the arrangement of the switches SW2, SW3, and SW4, but that any of variety of circuit configurations can be implemented to couple the respective tracking mode voltage V_{TRACK} and the seek mode voltage V_{SEEK} to the H-bridge circuit 56. For example, the mode signal MODE can be implemented as two separate signals to individually control the switches SW3 and SW4, thus obviating the second switch SW2. Accordingly, the disk-drive motor driver 50 can be configured in any of a variety of ways.

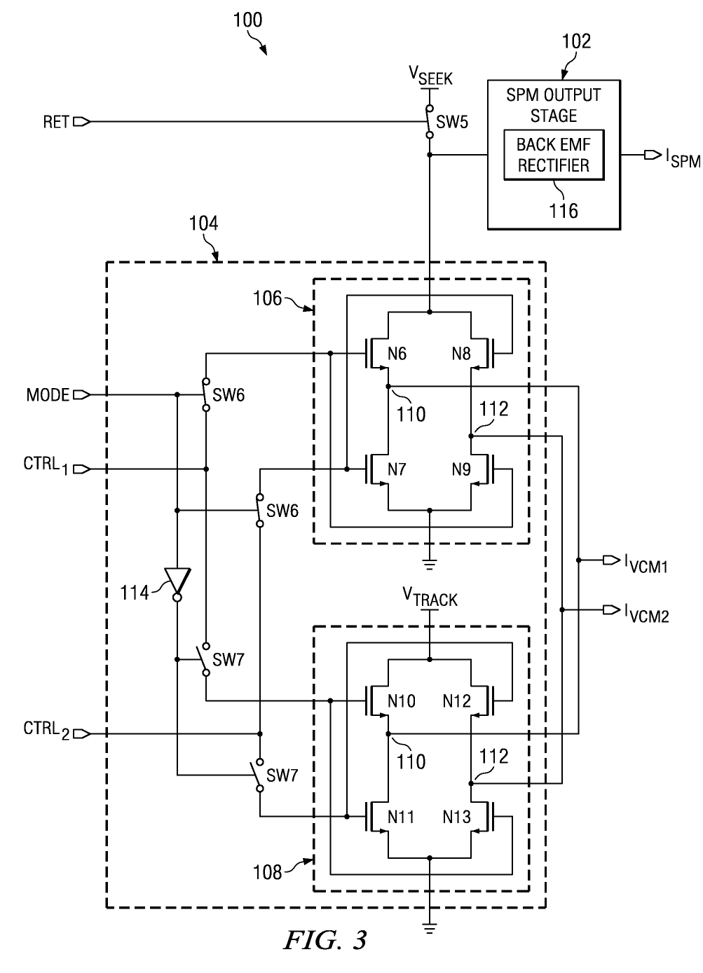

FIG. 3 illustrates another example of a disk-drive motor driver 100 in accordance with an aspect of the invention. The disk-drive motor driver 100 can be configured substantially similar to the disk-drive motor driver 16 in the example of FIG. 1. As such, reference is to be made to the example of FIG. 1 in the following description of the example of FIG. 3.

The disk-drive motor driver 100 includes an SPM output stage 102 and a VCM output stage 104. In the example of FIG. 3, the SPM output stage 102 is coupled to the seek mode voltage V_{SEEK}, such as provided from the seek mode power supply 26 in the example of FIG. 1, via a switch SW5 that is controlled by a signal RET. As such, the seek mode voltage V_{SEEK} is provided as a positive rail voltage to power the SPM output stage 102. Similar to as described above, the SPM output stage 102 is configured to generate a current I_{SPM} that controls an associated SPM, such as the SPM 12 in the example of FIG. 1. Thus, the SPM output stage 102 generates the current I_{SPM} based on the seek mode voltage V_{SEEK}. As an example, the SPM output stage 102 can be configured to control the current I_{SPM} in response to one or more control signals (not shown).

The VCM output stage 104 includes a first H-bridge circuit 106 and a second H-bridge circuit 108. The first H-bridge circuit 106 includes four N-type FETs N6, N7, N8, and N9. The transistor N6 interconnects the seek mode voltage V_{SEEK} and a first output node 110, and has a gate that is coupled to a first control signal CTRL₁. The transistor N7 interconnects the first output node 110 and a negative rail voltage, demonstrated in the example of FIG. 3 as ground, and has a gate that is coupled to a second control signal CTRL₂. The transistor N8 interconnects the seek mode voltage V_{SEEK} and a second output node 112, and has a gate that is coupled to the second control signal CTRL₂. The transistor N9 interconnects the second output node 112 and ground, and has a gate that is coupled to the first control signal CTRL₁. As an example, the first and second control signals CTRL₁ and CTRL₂ can be included in the control signals CTRL in the example of FIG. 1.

The second H-bridge circuit 108 includes four N-type FETs N10, N11, N12, and N13. The transistor N10 interconnects the tracking mode voltage V_{TRACK} and the first output node 110, and has a gate that is coupled to the first control signal CTRL₁. The transistor N11 interconnects the first output node 110 and ground, and has a gate that is coupled to the second control signal CTRL₂. The transistor N12 interconnects the tracking mode voltage V_{TRACK} and the second output node 112, and has a gate that is coupled to the second control signal CTRL₂. The transistor N13 interconnects the second output node 112 and ground, and has a gate that is coupled to the first control signal CTRL₁.

Similar to as described above in the example of FIG. 2, based on the states of the control signals CTRL₁ and CTRL₂, each of the first H-bridge circuit 106 and the second H-bridge circuit 108 can be configured to provide a current path for the current I_{VCM} through the associated VCM (not shown). Specifically, the example of FIG. 3 demonstrates that a current I_{VCM1} is provided from the first output node 110 and a current I_{VCM2} is provided from the second output node 112, such that one of the currents I_{VCM1} and I_{VCM2} can be provided to the associated VCM and the other of the currents I_{VCM1} and I_{VCM2} can be provided as a return path from the associated VCM to ground. Accordingly, the direction of movement of the magnetic disk read/write head can be appropriately controlled.

The VCM output stage 104 also includes a first pair of switches SW6 and a second pair of switches SW7. As an example, the switches SW6 and SW7 can be configured as transistors, such as FETs. The first pair of switches SW6 interconnect the control signals CTRL₁ and CTRL₂ to the first H-bridge circuit 106 and the second pair of switches SW7 interconnect the control signals CTRL₁ and CTRL₂ to the second H-bridge circuit 108. The first pair of switches SW6 is controlled by the mode signal MODE and the second pair of switches SW7 is controlled by an inverted state of the mode signal MODE via an inverter 114. Therefore, at a first state of the mode signal MODE corresponding to the seek mode, the switches SW6 are activated, such that the control signals CTRL₁ and CTRL₂ control the first H-bridge circuit 106 to provide the currents I_{VCM1} and I_{VCM2} to the associated VCM at a greater magnitude based on the greater magnitude seek mode voltage V_{SEEK}. Similarly, at a second state of the mode signal MODE corresponding to the tracking mode, the switches SW7 are activated, such that the control signals CTRL₁ and CTRL₂ control the second H-bridge circuit 108 to provide the currents I_{VCM1} and I_{VCM2} to the associated VCM at a lesser magnitude based on the lesser magnitude tracking mode voltage V_{TRACK}. As a result, during the tracking mode, the VCM output stage 104 can generate the current to the associated VCM based on the lower magnitude tracking mode voltage V_{TRACK} to substantially reduce power consumption.

In addition, in the example of FIG. 3, the SPM output stage 102 includes a back-EMF rectifier 116. The back-EMF rectifier 116 can be configured to rectify back-EMF voltage associated with the associated SPM to provide the rectified back-EMF voltage as a voltage source for the currents I_{VCM1} and I_{VCM2} to the associated VCM. In the example of FIG. 3, the back-EMF rectifier 116 can work in conjunction with the mode signal MODE and the control signals CTRL₁ and CTRL₂ to provide a current path from the back-EMF rectifier 116 to the associated VCM through the first H-bridge circuit 106. Thus, upon a detected power-loss associated with the tracking mode voltage V_{TRACK} and/or the seek mode power supply V_{SEEK}, the signal RET, the mode signal MODE, and one of the control signals CTRL₁ or CTRL₂ can be asserted to initiate a head-retraction mode. As a result, the switch SW5 is opened to decouple the SPM output stage 102 from the seek mode voltage V_{SEEK}. Accordingly, a current path is provided from the SPM output stage 102 through the associated VCM as the current I_{VCM1} or I_{VCM2} to ground. As a result, the magnetic disk read/write head can be retracted in event of a loss of the tracking mode voltage V_{TRACK} and/or the seek mode voltage V_{SEEK}, thus substantially preventing damage to the magnetic disk.

It is to be understood that the disk-drive motor driver 100 is not intended to be limited to the example of FIG. 3. As an example, the H-bridge circuits 106 and 108 are not limited to the use of N-type FETs, but they could implement some or all of the transistors therein as P-type FETs. In addition, the switching between the tracking mode and the seek mode is not limited to the arrangement of the switches SW6 and SW7, but that any of variety of circuit configurations can be implemented to provide the currents I_{VCM1} and I_{VCM2} to the associated VCM in each of the respective tracking and seek modes. Similarly, the disk-drive motor driver 100 is not limited to the arrangement of the control signals CTRL₁ and CTRL₂, but could have separate control signals control each of the respective H-bridge circuits 106 and 108, or could have a single control signal and an inverter control the transistors in each of the respective H-bridge circuits 106 and 108. Furthermore, the disk-drive motor driver 100 could include one or more additional transistors that bypass the first H-bridge circuit 106 from the SPM output stage 102 to the respective first output node 110 or second output node 112. Thus, the additional bypass transistors could be controlled by a retraction signal to provide the current path for the back-EMF rectified voltage in the head-retraction mode. Accordingly, the disk-drive motor driver 100 can be configured in any of a variety of ways.

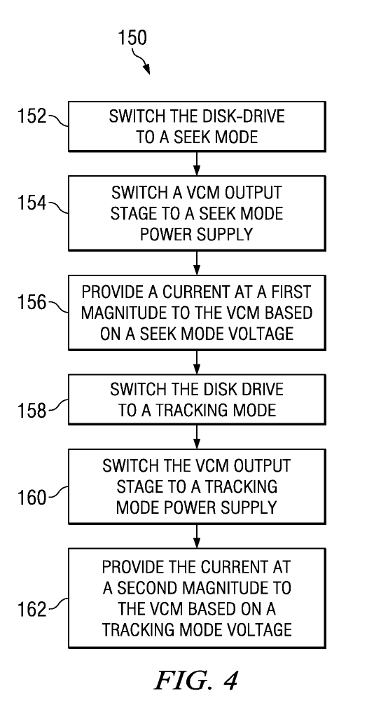

In view of the foregoing structural and functional features described above, certain methods will be better appreciated with reference to FIG. 4. It is to be understood and appreciated that the illustrated actions, in other embodiments, may occur in different orders and/or concurrently with other actions. Moreover, not all illustrated features may be required to implement a method.

FIG. 4 illustrates an example of a method 150 for controlling a disk-drive voice coil motor in accordance with an aspect of the invention. At 152, a disk-drive is switched to a seek mode. The seek mode can correspond to a VCM moving across the magnetic disk to a specific location to read data from or write data to the magnetic disk. At 154, a VCM output stage is switched to a seek mode power supply. As an example, the VCM output stage can activate a switch to couple an H-bridge circuit to the seek mode power supply. As another example, the VCM output stage can activate one or more switches to couple control signals corresponding to the VCM motion direction to the one of two H-bridges that is coupled to the seek mode power supply. At 156, a current is provided at a first magnitude to the disk-drive VCM based on the seek mode voltage. As an example, the seek mode voltage can be approximately 5 volts. The current can be provided through an associated H-bridge in one of two directions based on the state of control signals that control transistors in the H-bridge.

At 158, the disk-drive is switched to a tracking mode. The tracking mode can correspond to a VCM remaining substantially stationary or moving slowly across the magnetic disk to remain in a specific location while data is read from or written to the magnetic disk. At 160, the VCM output stage is switched to a tracking mode power supply. As an example, the VCM output stage can activate a switch to couple an H-bridge circuit to the tracking mode power supply. As another example, the VCM output stage can activate one or more switches to couple control signals corresponding to the VCM motion direction to the one of two H-bridges that is coupled to the tracking mode power supply. At 162, the current is provided at a second magnitude to the disk-drive VCM based on the tracking mode voltage. As an example, the tracking mode voltage can be approximately 2-3 volts, thus providing lesser current to the VCM. The current can be provided through an associated H-bridge in one of two directions based on the state of control signals that control transistors in the H-bridge. Therefore, in the tracking mode, the disk-drive can substantially conserve power.

What have been described above are examples of the invention. It is, of course, not possible to describe every conceivable combination of components or methodologies for purposes of describing the invention, but one of ordinary skill in the art will recognize that many further combinations and permutations of the invention are possible. Accordingly, the invention is intended to embrace all such alterations, modifications, and variations that fall within the scope of this application, including the appended claims.

1. A disk-drive motor control system comprising:
a seek mode power supply configured to provide a first voltage corresponding to a seek mode associated with a disk-drive voice control motor (VCM);
a track mode power supply configured to provide a second voltage corresponding to a tracking mode associated with the disk-drive VCM, the first voltage being greater than the second voltage; and
a disk-drive motor driver configured to provide a current to the disk-drive VCM at a first magnitude in the seek mode based on the first voltage, at a second magnitude in the tracking mode based on the second voltage, and at a third magnitude in a head-retraction mode,
wherein the disk-drive motor control system reduces power by supply voltage switching.

2. The system of claim 1, wherein the disk-drive motor driver comprises a VCM output stage configured to control the disk-drive VCM and a spindle motor (SPM) output stage configured to control a disk-drive SPM.

3. The system of claim 2, wherein the SPM output stage comprises a rectifier configured to provide the current to the disk-drive VCM during the head-retraction mode based on rectified back-electromagnetic field (EMF) voltage from the disk-drive SPM, the disk-drive VCM being isolated from the first voltage and the second voltage during the head-retraction mode.

4. The system of claim 3, wherein the disk-drive motor driver further comprises a switch configured to provide a current path for the current from the back-EMF rectifier to the disk-drive VCM in response to a head-retraction signal.

5. The system of claim 3, wherein the VCM output stage comprises an H-bridge circuit configured to provide a current path for the current to the disk-drive VCM during both the seek mode and the head-retraction mode based on a plurality of control signals.

6. The system of claim 2, wherein the VCM output stage comprises an H-bridge circuit configured to provide the current in one of two directions through the disk-drive VCM in response to a plurality of control signals.

7. The system of claim 6, wherein the VCM output stage comprises a first switch configured to couple the first voltage to the H-bridge circuit during the seek mode to provide the current at the first magnitude and a second switch configured to couple the second voltage to the H-bridge circuit during the tracking mode to provide the current at the second magnitude.

8. The system of claim 6, wherein the H-bridge circuit is a first H-bridge circuit that is coupled to the seek mode power supply and is configured to provide the current to the disk-drive VCM in the seek mode, the VCM output stage further comprising a second H-bridge circuit that is coupled to the tracking mode power supply and is configured to provide the current to the disk-drive VCM in the tracking mode.

9. The system of claim 2, wherein the SPM output stage is coupled to the seek mode power supply.

10. The system of claim 1, wherein the disk-drive motor driver is configured to enter the head-retraction mode in response to a power loss associated with at least one of the seek mode power supply and the tracking mode power supply.

11. A method for controlling a disk-drive, the method comprising:
switching a disk-drive voice control motor (VCM) to a seek mode power supply via a first H-bridge circuit upon the disk-drive entering a seek mode;
providing a current at a first magnitude to the disk-drive VCM through the first H-bridge circuit during the seek mode;
switching the disk-drive VCM to a tracking mode power supply via a second H-bridge circuit upon the disk-drive entering a tracking mode; and
providing the current at a second magnitude to the disk-drive VCM through the second H-bridge circuit during the tracking mode, the first magnitude being greater than the second magnitude,
wherein the method for controlling the disk-drive reduces power by supply voltage switching.

12. The method of claim 11, further comprising providing the current at a third magnitude to the disk drive VCM through the first H-bridge circuit during a head-retraction mode.

13. The method of claim 12, further comprising entering the head-retraction mode in response to a power-loss associated with at least one of the seek mode power supply and the tracking mode power supply.

14. The method of claim 12, further comprising:
rectifying back-electromagnetic field (EMF) voltage from a disk-drive spindle motor (SPM); and
generating the current at the third magnitude based on the rectified back-EMF voltage.

15. The method of claim 14, further comprising providing a voltage from the seek mode power supply to the disk-drive SPM.

16. A disk-drive motor control system comprising:
means for providing a first voltage corresponding to a seek mode associated with a disk-drive voice control motor (VCM);
means for providing a second voltage corresponding to a tracking mode associated with the disk-drive VCM, the first voltage being greater than the second voltage;
means for providing a third voltage corresponding to a head-retraction mode associated with the disk-drive VCM; and
means for providing a current to the disk-drive VCM at one of a first magnitude based on the first voltage in the seek mode, a second magnitude based on the second voltage in the tracking mode, and a third magnitude based on the third voltage in the head-retraction mode,
wherein the disk-drive motor control system reduces power by supply voltage switching.

17. The system of claim 16, wherein the means for providing the third voltage comprises means for rectifying a back-electromagnetic field (EMF) voltage from a disk-drive spindle motor.

18. The system of claim 16, wherein the means for providing the current comprises:
means for switching the disk-drive VCM to the means for providing the first voltage and the third voltage in the seek mode and in the head-retraction mode, respectively; and
means for switching the disk-drive VCM to the means for providing the second voltage in the tracking mode.

19. The system of claim 16, further comprising means for switching the means for providing the current to the means for providing the first voltage in the seek mode and to the means for providing the second voltage in the tracking mode.

20. The system of claim 16, wherein the means for providing the current comprises:
means for switching the disk-drive VCM to the means for providing the first voltage and the second voltage in the seek mode and in the tracking mode, respectively, and
means for switching the disk-drive VCM to the means for providing the third voltage in the head-retraction mode.
